(19) United States
(12) Patent Application Publication
(10) Pub. No.: US 2025/0340708 A1
(43) Pub. Date: Nov. 6, 2025

(54) COATING FOR RUBBER AND PLASTIC PRODUCTS

(71) Applicant: Timothy J. VanderHeiden, Chico, CA (US)

(72) Inventor: Timothy J. VanderHeiden, Chico, CA (US)

(21) Appl. No.: 18/653,827

(22) Filed: May 2, 2024

(51) Int. Cl. C08J 7/04; C09D 175/04

(52) U.S. Cl. CPC C08J 7/042; C09D 175/04; C08J 2300/30; C08J 2317/00; C08J 2321/00

(57) ABSTRACT

Disclosed is a process for coating a product made of one or more of: rubber, recycled rubber, plastic, or recycled plastic. The product is coated with a base layer of an aromatic polyurethane mixture and then a top layer of a water-based aliphatic polyurethane. The top coating may include a colorant. The method provides an economical way to produce a recycled rubber product that has a uniform color.

### TECHNICAL FIELD

The present subject matter relates to the field of colorization of molded recycled tire rubber particularly to materials, apparatus, and methods for coating recycled waste tire molded rubber products and waste plastic molded products.

### BACKGROUND

The current present-day process of colorizing molded rubber, including recycled tire rubber, is performed utilizing antiquated practices. One practice includes using EPDM a synthetic rubber material made from (ethylene propylene diene terpolymer) mixed in with the crumb rubber and then molded. This process does not provide for homogeneous colorization coverage of the manufactured part. These parts appear with small specks of colorant throughout the material surface. In this application colorization is dispersed conservatively and does not provide for a complete color appearance, rather provides an accent to the finished part. This material is expensive and does not allow for a stable finished topcoat appearance.

Another traditional colorization methodology is to coat the rubber (crumb) particles with an iron oxide powder or colored liquid urethane and then use this colored crumb material, combined with a urethane binder to be placed in hydraulic compression molding equipment to make the finished part. Compression and injection molding are typical to the process of producing recycled waste tire rubber products. While extrusion is also used in certain instances, this is limited to a linear set of products, and is not generally applied to commercial and consumer product lines that demand homogeneous color products in appearance.

Utilizing iron oxide for homogeneous color application is short lived, and this coating results in merely microns of thickness of color for these products which results in unfavorable outcomes. When exposed to UV these parts and colorants result in severe fading and discoloration because of the limited mil-thickness of this coating, thus this colorant process is fragile, weak and debatable.

Moreover, the use of iron oxide as a colorant succumbs to foot traffic in a short period of time which results in a significant wear pattern as the colorant is removed with depletion and ablation from foot traffic or vehicle use. The resulting product appearance is a dark color black traffic pattern, as the original tire rubber is exposed to the environment. The architectural community is keenly aware of the short life span of these materials and infrequently specify iron oxide or urethane rubber coated products.

A known method for achieving a solid color on recycled tire rubber was to overlay a thin sheet of original EPDM or synthetic sheet of (SBR) styrene-butadiene rubber. EPDM sheeting is usually introduced into the mold surface prior to the compression and heat process. This material is noticeably expensive, generally used for accent purposes and does not encapsulate the entire rubber part.

As a result of the oil and paraffins and other additives in tire manufacturing, methods for topically coating a molded tire product or product made from recycled waste tire rubber are unsatisfactory. Typically, when topically applying coating materials to existing molded products, coatings fail for multiple reasons. These include inclement weather where the rubber expands under varying degrees of ambient temperature and, as a result, the topical coatings delaminate. In other instances, when painted parts were exposed to water the molded rubber parts absorb moisture which releases and delaminates the coating material. In other instances, under friction and wear topically applied coatings delaminate and come loose and tear away. Ultimately, applied coating material does not adhere to waste tire rubber parts.

Another reason that topically applied coating material does not adhere to molded rubber parts is the result of the mold release used in the molding process. Most commonly waste tire rubber parts are made utilizing compression molding. This occurs under powerful hydraulic compression machines, often with heated platens or molds, and is mixed with adhesive and or urethane binders and then placed into the selected molds.

Especially in compression molding operations, rubber products utilize diverse types of mold release(s). Such release agents are often silicon based, and are applied to the surface of the steel, aluminum, wood, or polymer mold prior to the placement of prepared crumb rubber. These release agents transfer to the rubber part in the compression process and are imbedded in the finished part. The release agent negatively impacts the use of any topically applied color coating to a crumb rubber part.

When topically applied, coatings to tire rubber parts do not withstand bending, twisting or part movement because elongation in the typically coated material do not withstand movement or flexing of the substrate rubber material. The movement results in the delamination and the separation of the coating.

Thus, there is a need for a topically applied colorfast colorant to molded recycled tire material that can withstand inclement weather, UV exposure, foot, vehicle traffic abrasion, freeze thaw and extreme heat, while also endure moderate flexion.

### BRIEF DESCRIPTION OF THE DRAWINGS

The embodiments are illustrated by way of example and not limitation in the figures of the accompanying drawings, in which like references indicate similar elements, and in which:

FIG. 1 is a chromatogram plot of an analysis of part of a coating of an embodiment by gas chromatograph/mass spectrometry; and

FIG. 2A-FIG. 2K are spectra from peaks of the chromatogram of FIG. 1 accompanied by spectra from a library search.

### DETAILED DESCRIPTION

The disclosed subject matter provides a method for encapsulating a product made of one or both of rubber or plastic, including recycled tire rubber and recycled plastic, thereby making the product more attractive and preventing chemicals from leaching into the environment. There is a need for greater use of products made from recycled waste tires, in particular. In California alone, with all of the regulatory mandates, 62% of all waste tires head the landfills.

Unfortunately, as a result of tire rubber and its hydrophobic nature to dirt and oil, black recycled tire material is not attractive because it shows footprints and vehicle traffic marks resulting from use. The motivation for the methods disclosed within is to provide a superior product offering that will create demand for recycled waste tire molded parts.

While there exists no current answer to adequately and affordably colorize recycled tire products today, disclosed within is a method for encapsulating recycled waste tire rubber parts so that chemicals such as phenanthrene, pyrene, acenaphthylene and naphthalene, which are the natural compounds of tire rubber, are prevented from leaching out into our environment with product use.

Another important reason to utilize this coating process and product for rubber encapsulation is that it has been recently found that the chemical profile for motor vehicle tires contains N-(1,3-Dimethylbutyl)-N′-phenyl-pphenylenediamine referred to as (6PPD). 6PPD has been used as an anti-degradant for decades and is found in most, if not all, motor vehicle tires. 6PPD performs the critical function of protecting rubber from reactions with ozone and oxygen, which can lead to cracks. However, 6PPD is toxic to aquatic organisms at multiple trophic levels, can impair wildlife survival, and is toxic to algae. 6PPD-quinone, a reaction product of 6PPD, is acutely toxic to coho salmon and kills fish within a few hours after exposure. While little is known about the effect of 6PPD-quinone on other organisms, 6PPD-quinone may also be toxic to closely related species such as trout, steelhead and chinook.

Thus, encapsulating molded tire rubber would prevent the leaching of harmful chemicals that exist in tire products. Recycling waste tire products does nothing to retard the exposure of these chemicals to the environment subsequent to the molding of the products. Through encapsulating such parts in the material described in embodiments will the leaching of these chemicals into the environment be prevented.

In an embodiment, a method for coating recycled rubber includes an application of a base layer of an aromatic polyurethane coating. This adhesive pre-coat overcomes the concerns of mold release contamination. The aromatic polyurethane coating is then top coated using a water-based aliphatic polyurethane. Optionally, the top coat may be colorized to enhance its appearance.

In an embodiment, the base layer may include a Part A and a Part B mixed in unequal amounts, with Part A being an aromatic isocyanate hardener and Part B being an aromatic polyurethane. In an embodiment, the ratio of the A/B mixture is one part Part A to two parts Part B.

In some embodiments, Part A is a compound including the ingredients at the weight percentages given in Table 1. In an embodiment, Part A may be 100% polymeric isocyanates. Part A as described in Table 1 is available commercially as Freedom Tuff® 4300-A from Freedom® Chemical Corporation, 19685 Descartes, Foothill Ranch, CA 92610.

TABLE 1

| | | CAS (Chemical Abstract |
|---|---|---|
| Chemical Name | Wt. % | Service) Number |
| Polymeric Isocyanates | 70-100 | 9016-87-9 |
| Methylene Bisphenyl Isocyanate | 5-15 | 101-68-8 |
| Diphenylmethane-2,4′-di-isocyanate | 3-7 | 5873-54-1 |
| Diphenylmethane-2,2′-di-isocyanate | <1 | 2536-05-2 |

In some embodiments, Part B is a compound including the ingredients at the weight percentages given in Table 2. In an embodiment, Part B may be 40-50 weight percent castor oil. Part B as described in Table 2 is available commercially as Freedom Tuff® 4300-B, from Freedom® Chemical Corporation, 19685 Descartes, Foothill Ranch, CA 92610.

| Chemical Name | Wt. % | CAS registry number |
|---|---|---|
| Castor Oil | 40-50 | 8001-79-4 |
| Polyols | 50-60 | See within |

In other embodiments, in Part B, one or more different oils may be included with or in place of castor oil to reach the 50-60 weight percentage. Such different oils may include one or more of: coconut oil, jojoba oil, olive oil, almond oil, argan oil, avocado oil, black seed oil, and/or shea butter.

In an embodiment, the polyols of Table 2 may be include tripropylene glycol and its derivatives.

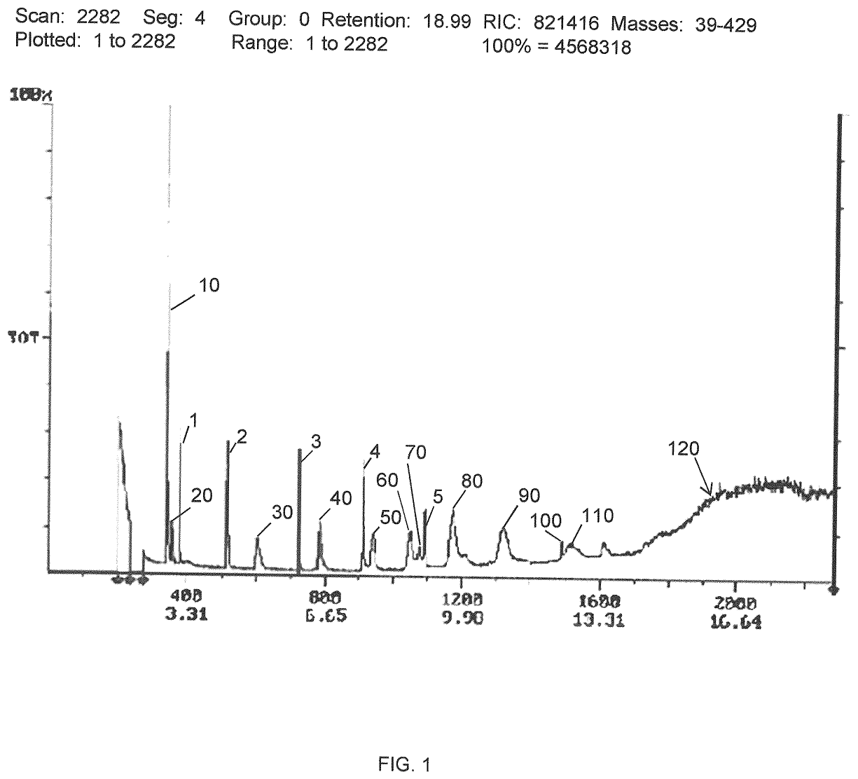

In an embodiment, when an embodiment of Part B, i.e., Freedom Tuff® 4300-B, is analyzed by thermogravimetric analysis per ASTM D6370: the volatile content is 1.21%, the polymer oil content is 96.4%, the organic content is 1.23%, and the inorganic residue is 1.07%. When this embodiment of Part B is analyzed for metal content via Inductively Coupled Plasma (ICP): the aluminum content is 1230 mg/Kg; the potassium content is 782 mg/Kg; and the sodium content is 682 mg/Kg. When 0.10 g of this embodiment of Part B is dissolved in 10 mL of dichloromethane and injected into a gas chromatograph/mass spectrometer (GC/MS), the resulting total ion chromatogram of FIG. 1 exhibits a profile of uniformly distributed peaks indicating that the glycol derivatives are of a uniformly distributed molecular weight and boiling point. The peak shape is consistent with these being polar compounds, and with Part B being a glycol mixture containing tripropylene glycol and derivatives that may contain subtle methyl and ethyl groups in varying configurations. The sharp peaks 1, 2, 3, 4, and 5, at approximately scan numbers 400, 500, 700, 900 and 1100, respectively, are non-polar internal standards that were added to the extract and exhibit a sharper peak shape due to the better interaction with the column phase. Peaks 10, 20, 30, 40, 50, 60, 70, 80, 90, 100, 110, and 120 represent peaks from this embodiment of Part B. The shape of peak 120 of FIG. 1 is consistent with castor oil.

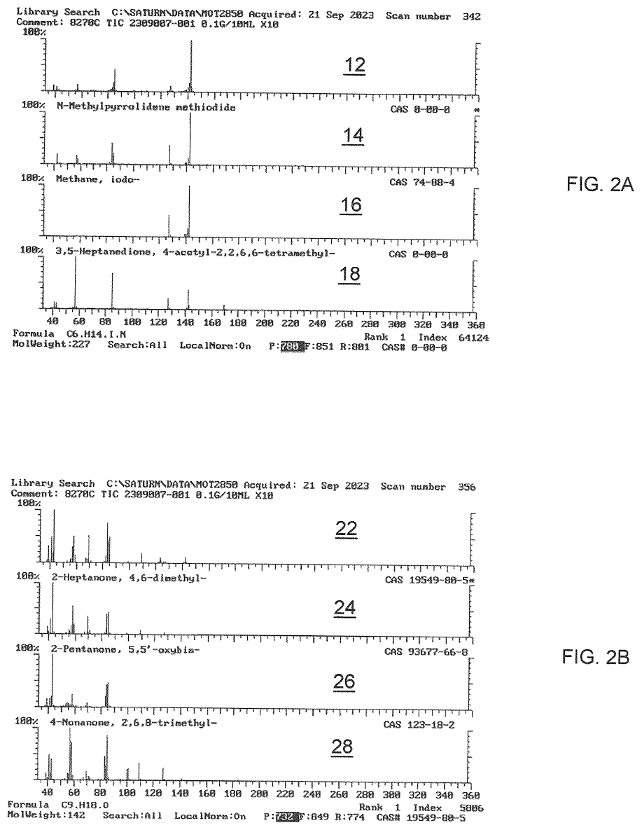

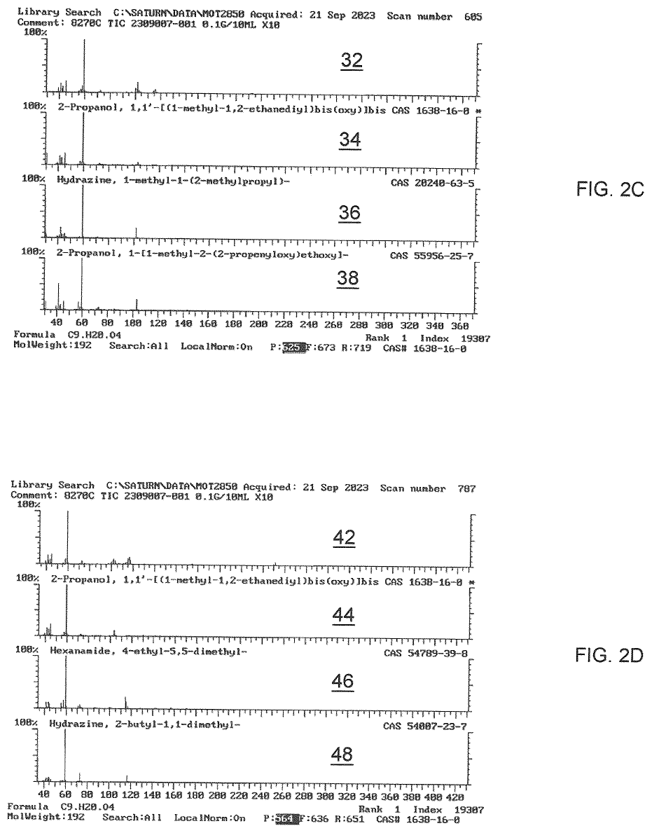

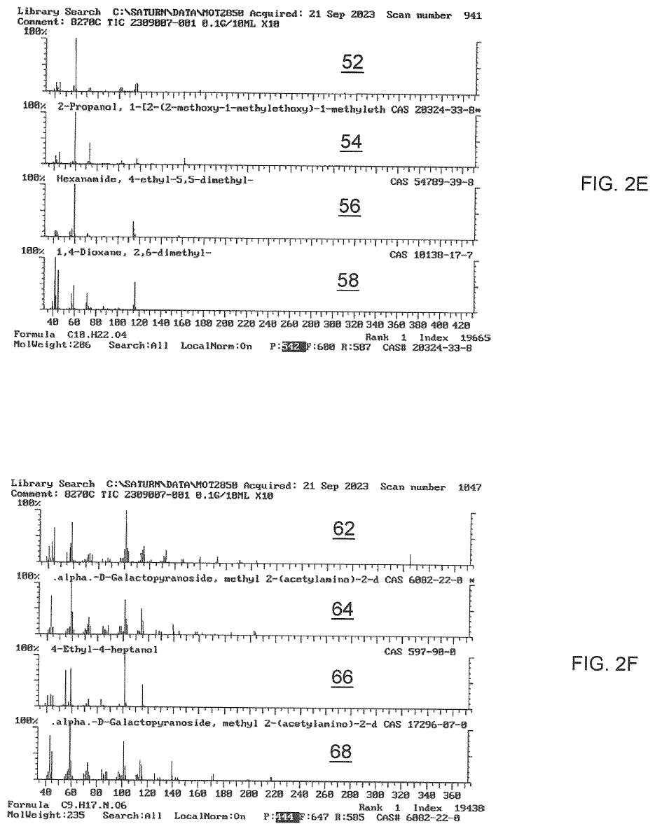

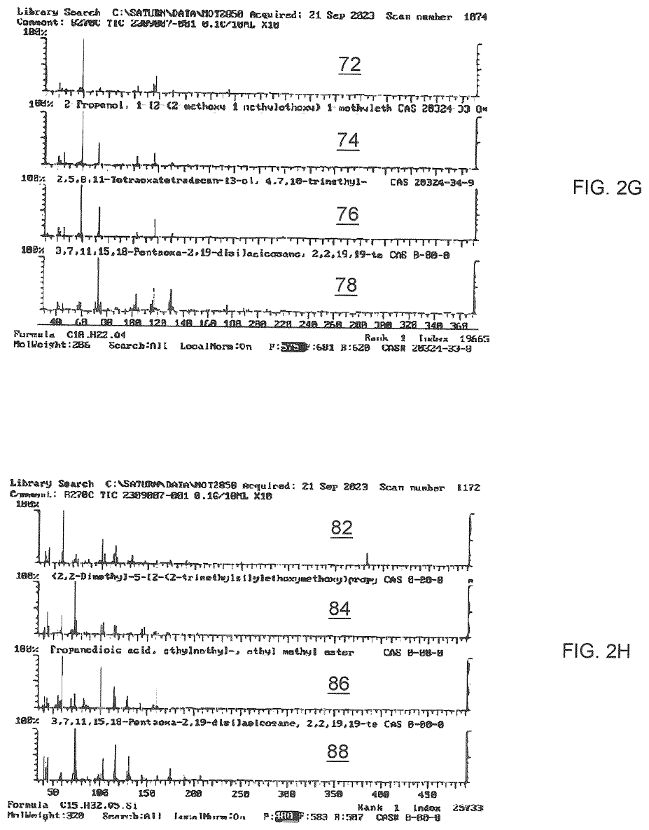

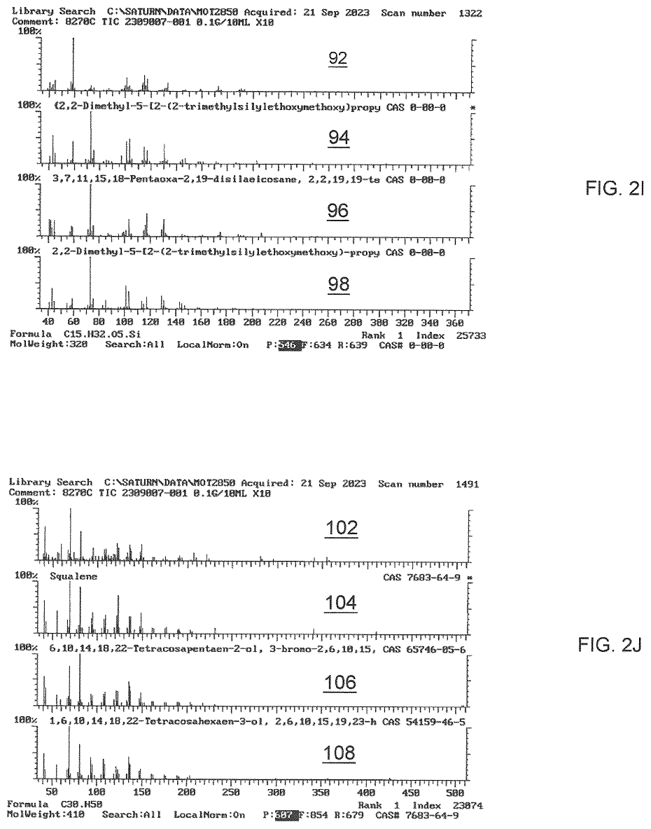

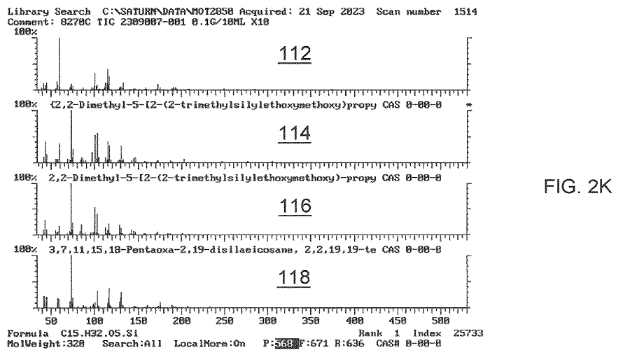

FIG. 2A-FIG. 2K contain sample spectra from each of sample peaks 10, 20, 30, 40, 50, 60, 70, 80, 90, 100, 110, respectively, as the uppermost spectrum in the figure, followed by the three most probable matches from a library search conducted against the sample spectrum. In each of FIG. 2A-FIG. 2K, the data at the bottom of the figure regards the most likely search, with the “P:nnn” value representing a probability ×1000 of the match being correct. For example, in FIG. 2A, the probability that scan 342 within peak 10 is N-Methylpyrrolidene methiodide 14 is 78.0%.

FIG. 2A contains a spectrum 12 of peak 10 of FIG. 1 along with the three most likely matches 14, 16, 18 from a library search conducted against spectrum 12. The probability that scan 342 within peak 10 is N-Methylpyrrolidene methiodide 14 is 78.0%. Scan 342 may also be Methane, iodo- (CAS 74-88-4) 16; or 3,5-Heptanedione, 4-acetyl-2,2,6,6-tetramethyl- (CAS 0-00-0) 18.

FIG. 2B contains a spectrum 22 of peak 20 of FIG. 1 along with the three most likely matches 24, 26, 28 from a library search conducted against spectrum 22. The probability that scan 356 within peak 20 is 2-Heptanone, 4,6-dimethyl- (CAS 19549-80-5) 24 is 73.2%. Scan 356 may also be: 2-Pentanone, 5,5′-oxybis- (CAS 93677-66-8) 26; or 4-Nonanone, 2,6,8-trimethyl- (CAS 123-18-2) 28.

FIG. 2C contains a spectrum 32 of peak 30 of FIG. 1 along with the three most likely matches 34, 36, 38 from a library search conducted against spectrum 32. The probability that scan 605 within peak 30 is 2-Propanol, 1,1′-[(1-methyl-1,2-ethanediyl)bis(oxy)]bis (CAS 1638-16-0) 34 is 62.5%. Scan 605 may also be: Hydrazine, 1-methy-1-(2-methylpropyl)- (CAS 20240-63-5) 36; or 2-Propanol, 1-[1-methyl-2-(2-propenyloxy)ethoxy]- (CAS 55956-25-7) 38.

FIG. 2D contains a spectrum 42 of peak 40 of FIG. 1 along with the three most likely matches 44, 46, 48 from a library search conducted against spectrum 42. The probability that scan 787 within peak 40 is 2-Propanol, 1,1′-[(1-methyl-1,2-ethanediyl)bis(oxy)]bis (CAS 1638-16-0) 44 is 56.4%. Scan 787 may also be: Hexanamide, 4-ethyl-5,5-dimethyl- (CAS 54789-39-8) 46; or Hydrazine, 2-butyl-1,1-dimethyl- (CAS 54007-23-7) 48.

FIG. 2E contains a spectrum 52 of peak 50 of FIG. 1 along with the three most likely matches 54, 56, 58 from a library search conducted against spectrum 52. The probability that scan 941 within peak 50 is 2-Propanol, 1-[2-(2-methoxy-1-methylethoxy)-1-methylethoxy (CAS 20324-33-8) 54 is 54.2%. Scan 941 may also be: Hexanamide, 4-ethyl-5,5-dimethyl- (CAS 54789-39-8) 56; or 1,4-Dioxane, 2,6-dimethyl- (CAS 10138-17-7) 58.

FIG. 2F contains a spectrum 62 of peak 60 of FIG. 1 along with the three most likely matches 64, 66, 68 from a library search conducted against spectrum 62. The probability that scan 1047 within peak 60 is .alpha.-D-Galactopyranoside, methyl 2-(acetylamino)-2-deoxy- (CAS 6082-22-0) 64 is 54.2%. Scan 1047 may also be: 4-Ethyl-4-heptanol (CAS 597-90-0) 66; or .alpha.-D-Galactopyranoside, methyl 2-(acetylamino)-2-deoxy-6-O-methyl- (CAS 17296-07-0) 68.

FIG. 2G contains a spectrum 72 of peak 70 of FIG. 1 along with the three most likely matches 74, 76, 78 from a library search conducted against spectrum 72. The probability that scan 1074 within peak 70 is 2-Propanol, 1-[2-(2-methoxy-1-methylethoxy)-1-methylethoxy]- (CAS 20324-33-8) 74 is 57.5%. Scan 1074 may also be: 2,5,8,11-Tetraoxatetradecan-13-ol, 4,7,10-trimethyl- (CAS 20324-34-9) 76; or 3,7,11,15,18-Pentaoxa-2,19-disilaeicosane, 2,2,19,19-tetramethyl- (CAS 0-00-0) 78.

FIG. 2H contains a spectrum 82 of peak 80 of FIG. 1 along with the three most likely matches 84, 86, 88 from a library search conducted against spectrum 82. The probability that scan 1172 within peak 80 is {2,2-Dimethyl-5-[2-(2-trimethylsilylethoxymethoxy)propyl (CAS 0-00-0) 84 is 40.0%. Scan 1172 may also be: Propanedioic acid, ethylmethyl-, ethyl methyl ester (CAS 0-00-0) 86; or 3,7,11,15,18-Pentaoxa-2,19-disilaeicosane, 2,2,19,19-tetramethyl- (CAS 0-00-0) 88.

FIG. 2I contains a spectrum 92 of peak 90 of FIG. 1 along with the three most likely matches 94, 96, 98 from a library search conducted against spectrum 92. The probability that scan 1322 within peak 90 is {2,2-Dimethyl-5-[2-(2-trimethylsilylethoxymethoxy)propyl (CAS 0-00-0) 94 is 54.6%. Scan 1322 may also be: 3,7,11,15,18-Pentaoxa-2,19-disilaeicosane, 2,2,19,19-tetramethyl- (CAS 0-00-0) 96; or 2,2-Dimethyl-5-[2-(2-trimethylsilylethoxymethoxy)-propyl][1,3]dioxolan-4-yl)methanol (CAS 0-00-0) 98.

FIG. 2J contains a spectrum 102 of peak 100 of FIG. 1 along with the three most likely matches 104, 106, 108 from a library search conducted against spectrum 102. The probability that scan 1491 within peak 100 is Squalene (CAS 7683-64-9) 104 is 60.7%. Scan 1491 may also be: 6,10,14,18,22-Tetracosapentaen-2-ol, 3-bromo-2,6,10,15,19,23-hexamethyl- (CAS 65746-05-6) 106; or 1,6,10,14,18,22-Tetracosahexaen-3-ol, 2,6,10,15,19,23-hexamethyl- (CAS 54159-46-5) 108.

FIG. 2K contains a spectrum 112 of peak 110 of FIG. 1 along with the three most likely matches 114, 116, 118 from a library search conducted against spectrum 112. The probability that scan 1514 within peak 110 is {2,2-Dimethyl-5-[2-(2-trimethylsilylethoxymethoxy)propyl (CAS 0-00-0) 114 is 56.8%. Scan 1514 may also be: 2,2-Dimethyl-5-[2-(2-trimethylsilylethoxymethoxy)-propyl][1,3]dioxolan-4-yl)methanol (CAS 0-00-0) 116; or 3,7,11,15,18-Pentaoxa-2,19-disilaeicosane, 2,2,19,19-tetramethyl- (CAS 0-00-0) 118.

In an embodiment, Part B may include one or more of the following (separated by semi-colons): N-Methylpyrrolidene methiodide (CAS 0-00-0); Methane, iodo- (CAS 74-88-4); 3,5-Heptanedione, 4-acetyl-2,2,6,6-tetramethyl- (CAS 0-00-0); 2-Heptanone, 4,6-dimethyl- (CAS 19549-80-5); 2-Pentanone, 5,5′-oxybis- (CAS 93677-66-8); 4-Nonanone, 2,6,8-trimethyl- (CAS 123-18-2); 2-Propanol, 1,1′-[(1-methyl-1,2-ethanediyl)bis(oxy)]bis (CAS 1638-16-0); Hydrazine, 1-methy-1-(2-methylpropyl)- (CAS 20240-63-5); 2-Propanol, 1-[1-methyl-2-(2-propenyloxy)ethoxy]- (CAS 55956-25-7); 2-Propanol, 1,1′-[(1-methyl-1,2-ethanediyl)bis(oxy)]bis (CAS 1638-16-0); Hexanamide, 4-ethyl-5,5-dimethyl- (CAS 54789-39-8); Hydrazine, 2-butyl-1,1-dimethyl- (CAS 54007-23-7); 2-Propanol, 1-[2-(2-methoxy-1-methylethoxy)-1-methylethoxy]- (CAS 20324-33-8); Hexanamide, 4-ethyl-5,5-dimethyl- (CAS 54789-39-8); 1,4-Dioxane, 2,6-dimethyl- (CAS 10138-17-7); .alpha.-D-Galactopyranoside, methyl 2-(acetylamino)-2-deoxy- (CAS 6082-22-0); 4-Ethyl-4-heptanol (CAS 597-90-0); .alpha.-D-Galactopyranoside, methyl 2-(acetylamino)-2-deoxy-6-O-methyl- (CAS 17296-07-0); 2,5,8,11-Tetraoxatetradecan-13-ol, 4,7,10-trimethyl- (CAS 20324-34-9); 3,7,11,15,18-Pentaoxa-2,19-disilaeicosane, 2,2,19,19-tetramethyl- (CAS 0-00-0); {2,2-Dimethyl-5-[2-(2-trimethylsilylethoxymethoxy)propyl (CAS 0-00-0); Propanedioic acid, ethylmethyl-, ethyl methyl ester (CAS 0-00-0); 3,7,11,15,18-Pentaoxa-2,19-disilaeicosane, 2,2,19,19-tetramethyl- (CAS 0-00-0); 3,7,11,15,18-Pentaoxa-2,19-disilaeicosane, 2,2,19,19-tetramethyl- (CAS 0-00-0); 2,2-Dimethyl-5-[2-(2-trimethylsilylethoxymethoxy)-propyl][1,3]dioxolan-4-yl)methanol (CAS 0-00-0); Squalene (CAS 7683-64-9); 6,10,14,18,22-Tetracosapentaen-2-ol, 3-bromo-2,6,10,15,19,23-hexamethyl- (CAS 65746 May 6); 1,6,10,14,18,22-Tetracosahexaen-3-ol, 2,6,10,15,19,23-hexamethyl- (CAS 54159-46-5); 2,2-Dimethyl-5-[2-(2-trimethylsilylethoxymethoxy)-propyl][1,3]dioxolan-4-yl)methanol (CAS 0-00-0); or 3,7,11,15,18-Pentaoxa-2,19-disilaeicosane, 2,2,19,19-tetramethyl- (CAS 0-00-0).

In an embodiment, Part B may include the following (separated by semi-colons): N-Methylpyrrolidene methiodide (CAS 0-00-0); 2-Heptanone, 4,6-dimethyl- (CAS 19549-80-5); 2-Propanol, 1,1′-[(1-methyl-1,2-ethanediyl)bis(oxy)]bis (CAS 1638-16-0); 2-Propanol, 1,1′-[(1-methyl-1,2-ethanediyl)bis(oxy)]bis (CAS 1638-16-0); 2-Propanol, 1-[2-(2-methoxy-1-methylethoxy)-1-methyleth (CAS 20324-33-8); .alpha.-D-Galactopyranoside, methyl 2-(acetylamino)-2-d (CAS 6082-22-0); 2-Propanol, 1-[2-(2-methoxy-1-methylethoxy)-1-methyleth (CAS 20324-33-8); and {2,2-Dimethyl-5-[2-(2-trimethylsilylethoxymethoxy)propyl (CAS 0-00-0).

In an embodiment, during manufacture of a product from recycled tire rubber, a surface preparation of the mold improves the durability of the coating on the final product and reduces the potential for delamination of the coating. The surface preparation is beneficial because there are paraffins and oils in recycled tire rubber, since motor oil is used in the production of tire products. When compressing recycled waste tire rubber using steel or aluminum molds under high pressure it is beneficial for the manufacturer to apply a mold release, e.g., by spraying the mold release on the mold surface prior to the compression molding process. Mold releases may be polysiloxanes-commonly called silicones. But there are many types of mold release. For example, the mold release may include: water-based mold release agents; solvent based mold release agents; silicone mold release agents; silicone-free mold release agents; a polyfluoroalkyl (PFA) coating and/or a type of fluoropolymer (PTFE) coating, e.g., Teflon. In an embodiment, the mold, itself, may be coated with one of: Dura Slick from PFI, Inc., Dyna-Tek® LLC's DT-420 base-coat and DT-6060 mold release, Parylene, or PFTE (e.g., Teflon),

In an embodiment, a product made of recycled tire rubber may be coated as follows. In an initial step, the ambient temperature is determined and, preferably, is from 50° F. to 90° F. Ambient temperatures below 50° F. have been found to lengthen the drying time of the A/B mixture. Drying ovens may be used to achieve a regulated drying temperature. The A/B mixture is created using one part Part A and two parts Part B. On mixing it is preferable to avoid encapsulating air. The product is then coated with two base coats of the A/B mixture. The application may be performed using typical paint rollers or spray systems. In an embodiment, for both roller and spray applications, the two coats of the applied A/B mixture, before drying, have a total thickness of from 1 mil to 3 mil. For example, a spray application may be achieved using a Graco XP50, part number 575205. Preferably the A/B mixture should be applied within 20-30 minutes of mixing.

In an embodiment, after the base A/B mixture coat has dried sufficiently, a top colorant coat may be applied using, e.g., a roller or spray machine. In this embodiment, a sufficient amount of time is the duration required to allow the applied A/B mixture to become tacky. For example, in drying at normal ambient temperatures, this duration may be approximately five minutes. In embodiments using a drying oven, the duration may be shorter. Preferably, as soon as the A/B mixture coat becomes tacky to the touch the top coat is applied. After the process becomes standardized, e.g., applying the A/B mixture to a predetermined thickness at a predetermined temperature, the duration allowed for drying may also be predetermined. In such a standardized method, whether the A/B mixture coat becomes tacky may no longer be the flag indicating that top-coating should begin.

In an embodiment, the top coat may be a water-based colorized aliphatic polyurethane. The top coat of a desired color may then be applied using similar methods, i.e., by roller or spray. In an embodiment, the top coat may be a Stobicoat® N 1830 color top coat. In some embodiments, a second top coat may be desirable to fully conceal the underlying rubber, e.g., when the top coat is yellow or white.

In some embodiments, a consideration in choosing a top coat includes determining whether the top coat, after it dries, will elongate sufficiently to allow the product to be manipulated without causing the top coat to crack. For example, with a part called a “transition” that was 8″ wide, 46″ long, and ⅞″ at its thickest, the part, after top coating, was manipulated by being bent at a 90-degree angle, even though the part in use would not normally experience such extensive deformation. The Stobicoat® top coat was determined to survive this treatment without cracking. Such a feature may be most beneficial for products that experience deformation when in use.

Embodiments have generally been described using a recycled tire rubber product as the base product. However, in embodiments, the product to be coated may be fashioned from a mixture of recycled tire rubber and recycled plastic, or of just recycled plastic. In embodiments, the product to be coated may be extruded, or compression molded, or injection molded.

In an embodiment, a method for coating recycled tire rubber includes the following steps. Step 1) applying a base layer including one or more coats of an A/B mixture as described previously to a product made from recycled tire rubber, recycled plastic, or a combination of recycled rubber and recycled plastic. Step 2) when the base layer becomes tacky, applying one or more top coats of a water-based aliphatic polyurethane. Optionally, in step 2, the aliphatic polyurethane may include a dispersion colorant. Optionally, step 3) applying, e.g., by spray or gravity feed, an aggregate for greater static coefficient of friction (SCOF) in the finished part, creating a slip-resistant finished part.

The previous description is provided to enable any person skilled in the art to practice the various aspects described herein. While the foregoing disclosure has been described in some detail for purposes of clarity and understanding, it will be clear to one skilled in the art from a reading of this disclosure that various changes in form and detail can be made without departing from the true scope of the invention. It is to be understood that the invention is not limited to any of the specifically recited methodologies, reagents, biological materials or instrumentation that are recited herein, where similar or equivalent methodologies, reagents, biological materials or instrumentation can be substituted and used in the construction and practice of the invention, and remain within the scope of the invention. It is understood that the description and terminology used in the present disclosure is for the purpose of describing particular embodiments of the invention only, and is not intended that the invention be limited solely to the embodiments described herein.

As used in this specification and the appended claims, singular forms such as “a”, “an” and “the” include plural referents unless the content clearly dictates otherwise. All industry and technical terms used herein have the same meaning as commonly understood by one of ordinary skill in the art or industry to which the invention pertains, unless defined otherwise. A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure. All structural and functional equivalents to the elements of the various aspects described throughout this disclosure that are known or later come to be known to those of ordinary skill in the art are expressly incorporated herein by reference and are intended to be encompassed by the claims.

All publications, patents, patent applications, and/or other documents cited in this application are incorporated by reference in their entirety for all purposes to the same extent as if each individual publication, patent, patent application, and/or other document were individually indicated to be incorporated by reference for all purposes.

1. A method comprising:
obtaining an object including one or more of: rubber, plastic, recycled tire rubber or recycled plastic;
applying to the object a first layer including an aromatic polyurethane coating; and
applying a second layer including a water-based aliphatic polyurethane to at least some of the first layer.

2. The method of claim 1, wherein the aromatic polyurethane coating is a mixture of:
one part of a first part including an aromatic isocyanate hardener;
two parts of a second part including an aromatic polyurethane.

3. The method of claim 1, wherein the aromatic polyurethane coating is a mixture of:
one part of a first part including: polymeric isocyanates; methylene bisphenyl isocyanate; diphenylmethane-2,4′-di-isocyanate; and diphenylmethane-2,2′-di-isocyanate; and
two parts of a second part including polyols.

4. The method of claim 3, wherein the first part includes by weight:
70-100 percent polymeric isocyanates; 5-15 percent methylene bisphenyl isocyanate; 3-7 percent diphenylmethane-2,4′-di-isocyanate; and less than one percent diphenylmethane-2,2′-di-isocyanate.

5. The method of claim 3, wherein the first part includes by weight: 100 percent polymeric isocyanates.

6. The method of claim 4, wherein the second part includes by weight:
50-60 percent polyols; and 40-50 percent castor oil.

7. The method of claim 6, wherein the 50-60 percent polyols includes: N-Methylpyrrolidene methiodide; 2-Heptanone, 4,6-dimethyl- (CAS 19549-80-5); 2-Propanol, 1,1′-[(1-methyl-1,2-ethanediyl)bis(oxy)]bis (CAS 1638-16-0); 2-Propanol, 1-[2-(2-methoxy-1-methylethoxy)-1-methyleth (CAS 20324-33-8); .alpha.-D-Galactopyranoside, methyl 2-(acetylamino)-2-d (CAS 6082-22-0); {2,2-Dimethyl-5-[2-(2-trimethylsilylethoxymethoxy)propyl; and Squalene (CAS 7683-64-9).

8. The method of claim 6, further comprising:
bringing the object, the first part, and the second part to a temperature of from 50° F. to 90° F.;
applying the first layer in two coats using a roller or a spray apparatus;
allowing the first layer to become tacky before applying the second layer; and
applying the second layer using a roller or a spray apparatus.

9. The method of claim 8, wherein the first layer, before drying, has a thickness of from 1 mil to 3 mil.

10. The method of claim 9, wherein a water-based aliphatic polyurethane includes a water-based colorized aliphatic polyurethane.

11. A product produced by a process comprising:
obtaining an object including one or both of: rubber, plastic, recycled tire rubber or recycled plastic;
applying to the object a first layer including an aromatic polyurethane coating; and
applying a second layer including a water-based aliphatic polyurethane to at least some of the first layer.

12. The product of claim 11, wherein the aromatic polyurethane coating is a mixture of:
one part of a first part including an aromatic isocyanate hardener;
two parts of a second part including an aromatic polyurethane.

13. The product of claim 11, wherein the aromatic polyurethane coating is a mixture of:
one part of a first part including: polymeric isocyanates; methylene bisphenyl isocyanate; diphenylmethane-2,4′-di-isocyanate; and diphenylmethane-2,2′-di-isocyanate; and
two parts of a second part including polyols.

14. The product of claim 13, wherein the first part includes by weight:
70-100 percent polymeric isocyanates; 5-15 percent methylene bisphenyl isocyanate; 3-7 percent diphenylmethane-2,4′-di-isocyanate; and less than 1 percent diphenylmethane-2,2′-di-isocyanate.

15. The product of claim 13, wherein the first part includes by weight: 100 percent polymeric isocyanates.

16. The product of claim 14, wherein the second part includes by weight:
50-60 percent polyols; and 40-50 percent of castor oil.

17. The method of claim 16, wherein the 50-60 percent polyols includes: N-Methylpyrrolidene methiodide; 2-Heptanone, 4,6-dimethyl- (CAS 19549-80-5); 2-Propanol, 1,1′-[(1-methyl-1,2-ethanediyl)bis(oxy)]bis (CAS 1638-16-0); 2-Propanol, 1-[2-(2-methoxy-1-methylethoxy)-1-methyleth (CAS 20324-33-8); .alpha.-D-Galactopyranoside, methyl 2-(acetylamino)-2-d (CAS 6082-22-0); {2,2-Dimethyl-5-[2-(2-trimethylsilylethoxymethoxy)propyl; and Squalene (CAS 7683-64-9).

18. The product of claim 16, the process further comprising:
bringing the object, the first part, and the second part to a temperature of from 50° F. to 90° F.;
applying the first layer in two coats using a roller or a spray apparatus;
allowing the first layer to become tacky before applying the second layer; and
applying the second layer using a roller or a spray apparatus.

19. The product of claim 18, wherein the first layer, before drying, has a thickness of from 1 mil to 3 mil.

20. The product of claim 19, wherein a water-based aliphatic polyurethane includes a water-based colorized aliphatic polyurethane.
